(19) United States
(12) Patent Application Publication
(10) Pub. No.: US 2008/0120019 A1
(43) Pub. Date: May 22, 2008

(54) Drive System And Control Method Of The Same

(75) Inventors: Toshio Inoue, Shizuoka-ken (JP); Makoto Yamazaki, Shizuoka-ken (JP); Osamu Harada, Aichi-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Aichi-Ken (JP)

(21) Appl. No.: 11/794,903

(22) PCT Filed: Apr. 14, 2006
(86) PCT No.: PCT/JP2006/308362

§ 371 Date: Jul. 9, 2007

(30) Foreign Application Priority Data
Apr. 14, 2005 (JP) 2005-116541

(51) Int. Cl. F02D 45/00

(52) U.S. Cl. 701/113; 60/311; 60/299

(57) ABSTRACT

On a first start of an engine after system activation, the start control technique of the invention gives a valve-closing instruction to close an exhaust flow changeover valve and thereby causes all the fuel exhaust introduced into an exhaust system to be discharged after transmission through an HC adsorbent (step S100). After confirmation of the closed position of the exhaust flow changeover valve (steps S110 and S120), the start control technique starts cranking the engine (step S130). Fuel injection control and ignition control are performed to start fuel injection from a fuel injection valve after elapse of a preset time period since the start of engine cranking and eventually start the engine (step S170). The fuel injection accordingly starts after substantial elimination of the fuel vapor accumulated in an air intake system due to oil-tight leakage of the fuel injection valve. This arrangement effectively prevents a variation in air-fuel ratio on or immediately after a start of the engine.

### TECHNICAL FIELD

The present invention relates to a drive system and a control method of the drive system. More specifically the invention pertains to a drive system including an internal combustion engine equipped with an exhaust treatment catalyst in an exhaust system, as well as to a control method of such a drive system.

### BACKGROUND ART

One proposed drive system has an adsorbent that is arranged in a branch pipe to absorb uncombusted hydrocarbon (HC) gas (see, for example, Japanese Patent Laying-Open Gazette No. H10-153112). The branch pipe is branched off from an exhaust pipe of an engine and is again joined to the exhaust pipe. This prior art drive system utilizes a negative pressure in an air intake system to open a valve disposed in the branch pipe on a start of the engine. In the open position of the valve, the exhaust gas of the engine is led to the branch pipe and goes through the adsorbent, which absorbs the uncombusted HC gas included in the exhaust gas. The HC gas absorbed to the adsorbent is released with an increase in temperature of the adsorbent and is led to the air intake system via an EGR pipe to be burned out.

### DISCLOSURE OF THE INVENTION

This prior art drive system may, however, cause unstable operation of the engine and poor emission on a start of the engine. In a stop condition of the engine, the fuel vapor may be accumulated in the air intake system due to oil-tight leakage of a fuel injection valve with elapse of time. The amount of the fuel vapor accumulated in the air intake system is not fixed but is varied depending upon the time elapsed since a stop of the engine. This undesirably causes a variation in air-fuel ratio on or immediately after a restart of the engine with engine cranking and fuel injection under such conditions. The variation in air-fuel ratio may lead to unstable operation of the engine and cause some trouble, for example, a misfire. One possible measure against this problem increases the amount of fuel injection on the start of the engine by taking into account the potential variation in amount of the fuel vapor accumulated in the air intake system. This, however, undesirably worsens the emission. As mentioned above, the proposed drive system utilizes the negative pressure in the air intake system to open the valve and lead the exhaust gas of the engine to the branch pipe for absorption of the uncombusted HC gas in the exhaust gas to the adsorbent. On a start of the engine with engine cranking, the valve-open timing may be too late to lead the exhaust gas to the branch pipe. In this case, the fuel vapor accumulated in the air intake system does not go through the branch pipe with the adsorbent but is directly discharged to the outside air.

The drive system and the drive system control method of the invention thus aim to prevent a variation in air-fuel ratio on or immediately after a start of an internal combustion engine. The drive system and the drive system control method of the invention also aim to improve emission on a start of the internal combustion engine. The drive system and the drive system control method of the invention further aim to ensure satisfaction of a power demand even during start control of the internal combustion engine.

In order to attain at least part of the above and the other related objects, the drive system and the drive system control method of the invention have the configurations discussed below.

The present invention is directed to a first drive system including an internal combustion engine equipped with an exhaust treatment catalyst in an exhaust system. The first drive system includes: a fuel exhaust adsorption unit that is arranged in the exhaust system to absorb a component of a fuel exhaust; a cranking structure that cranks the internal combustion engine; and a start control module that, in response to a start instruction of the internal combustion engine, controls the cranking structure to crank the internal combustion engine and controls the internal combustion engine to start fuel injection from a fuel injection valve and eventually start the internal combustion engine after cranking of the internal combustion engine progresses to a specific extent that is required for substantial elimination of a fuel vapor accumulated in an air intake system and in a combustion chamber.

In response to a start instruction of the internal combustion engine that is equipped with the exhaust treatment catalyst and the fuel exhaust adsorption unit in the exhaust system, the first drive system of the invention controls the cranking structure to crank the internal combustion engine and controls the internal combustion engine to start fuel injection from the fuel injection valve and eventually start the internal combustion engine after cranking of the internal combustion engine progresses to the specific extent that is required for substantial elimination of the fuel vapor accumulated in the air intake system and in the combustion chamber. The fuel injection is performed to start the internal combustion engine after substantial elimination of the fuel vapor accumulated in the air intake system and in the combustion chamber. This arrangement effectively prevents a variation in air-fuel ratio on or immediately after a start of the internal combustion engine. The fuel exhaust adsorption unit absorbs the component of the fuel exhaust flowed into the exhaust system in the course of cranking the internal combustion engine. This arrangement improves emission on a start of the internal combustion engine. The first drive system of the invention may be mounted a motor vehicle as its driving system. One typical application of the invention is thus a motor vehicle equipped with this first drive system.

The present invention is also directed to a second drive system including an internal combustion engine equipped with an exhaust treatment catalyst in an exhaust system. The second drive system includes: a fuel exhaust adsorption unit that is arranged in the exhaust system to absorb a component of a fuel exhaust; a changeover mechanism that is driven by an actuator to change over a flow path of the fuel exhaust between a first gas pathway that causes a main portion of the fuel exhaust introduced into the exhaust system to be discharged without transmission through the fuel exhaust adsorption unit and a second gas pathway that causes all the fuel exhaust introduced into the exhaust system to be discharged after transmission through the fuel exhaust adsorption unit; a cranking structure that cranks the internal combustion engine; and a start control module that, in response to a start instruction of the internal combustion engine, drives the actuator and controls the changeover mechanism to change over the flow path of the fuel exhaust to the second gas pathway and controls the internal combustion engine to start cranking the internal combustion engine and eventually start the internal combustion engine after the changeover of the flow path of the fuel exhaust to the second gas pathway by the changeover mechanism.

In the second drive system of the invention, the changeover mechanism is driven by the actuator to change over the flow path of the fuel exhaust between the first gas pathway that causes the main portion of the fuel exhaust introduced into the exhaust system to be discharged without transmission through the fuel exhaust adsorption unit and the second gas pathway that causes all the fuel exhaust introduced into the exhaust system to be discharged after transmission through the fuel exhaust adsorption unit. In response to a start instruction of the internal combustion engine that is equipped with the exhaust treatment catalyst and the fuel exhaust adsorption unit in the exhaust system, the second drive system of the invention drives the actuator and controls the changeover mechanism to change over the flow path of the fuel exhaust to the second gas pathway and controls the internal combustion engine to start cranking the internal combustion engine and eventually start the internal combustion engine after the changeover of the flow path of the fuel exhaust to the second gas pathway by the changeover mechanism. This arrangement desirably prevents direct discharge of the fuel vapor, which is accumulated in the air intake system and is flowed into the exhaust system in the course of cranking the internal combustion engine, without transmission through the fuel exhaust adsorption unit and thus improves the emission on a start of the internal combustion engine. The second drive system of the invention may be mounted a motor vehicle as its driving system. One typical application of the invention is thus a motor vehicle equipped with this second drive system.

In one preferable embodiment of the invention, the second drive system further includes a changeover detection unit that detects the changeover of the flow path of the fuel exhaust to the second gas pathway by the changeover mechanism. The start control module controls the cranking structure to start cranking the internal combustion engine, in response to detection of the changeover of the flow path of the fuel exhaust to the second gas pathway by the changeover detection unit. This arrangement more effectively prevents direct discharge of the fuel vapor, which is accumulated in the air intake system and is flowed into the exhaust system in the course of cranking the internal combustion engine, without transmission through the fuel exhaust adsorption unit.

In one preferable structure of the second drive system of the invention, the start control module controls the internal combustion engine to start fuel injection from a fuel injection valve and eventually start the internal combustion engine after cranking of the internal combustion engine progresses to a specific extent that is required for substantial elimination of a fuel vapor accumulated in an air intake system and in a combustion chamber. The fuel injection is performed to start the internal combustion engine after substantial elimination of the fuel vapor accumulated in the air intake system and in the combustion chamber. This arrangement effectively prevents a variation in air-fuel ratio on or immediately after a start of the internal combustion engine.

In the first and second drive system of the invention that controls the internal combustion engine to start fuel injection from a fuel injection valve and eventually start the internal combustion engine after cranking of the internal combustion engine progresses to a specific extent, the start control module may control the internal combustion engine to start the fuel injection from the fuel injection valve and start the internal combustion engine after cranking of the internal combustion engine continues for a predetermined time period, which expects the progress of cranking to the specific extent.

In the first and second drive system of the invention, the start control module may function in response to a first start instruction of the internal combustion engine after system activation.

In one preferable structure of either of the first drive system and the second drive system of the invention, the exhaust treatment catalyst is arranged downstream the fuel exhaust adsorption unit to convert the component of the fuel exhaust absorbed by the fuel exhaust adsorption unit and later released from the fuel exhaust adsorption unit. The component of the fuel exhaust released from the fuel exhaust adsorption unit is converted by the active exhaust treatment catalyst.

In one preferable embodiment of either of the first drive system and the second drive system of the invention, the drive system is designed to directly or indirectly use output power of the internal combustion engine and enable output of power to a driveshaft and further includes: a driveshaft motor that outputs power to the driveshaft; an accumulator unit that receives and transmits electric power from and to the driveshaft motor; and a power demand setting module that sets a power demand in response to an operator's manipulation. The start control module controls the driveshaft motor to output a power equivalent to the set power demand to the driveshaft. This arrangement ensures satisfaction of the power demand, although a relatively long time is required for a start of the internal combustion engine. In this embodiment, the start control module may control the driveshaft motor to output the power equivalent to the set power demand to the driveshaft within an output limit of the accumulator unit. This arrangement effectively prevents over discharge of the accumulator unit. In one preferable application, the drive system of this embodiment further includes an electric power-mechanical power input output mechanism that is connected with an output shaft of the internal combustion engine and with the driveshaft to function as the cranking structure with input and output of electric power and mechanical power and to output at least part of the output power of the internal combustion engine to the driveshaft after a start of the internal combustion engine. One typical example of the electric power-mechanical power input output mechanism includes: a three shaft-type power input output module that is linked to three shafts, the output shaft of the internal combustion engine, the driveshaft, and a third rotating shaft, and automatically inputs and outputs power from and to a residual one shaft based on powers input from and output to any two shafts among the three shafts; and a rotating shaft motor that is capable of inputting and outputting power from and to the third rotating shaft. Another typical example of the electric power-mechanical power input output mechanism is a pair-rotor motor that has a first rotor connected to the output shaft of the internal combustion engine and a second rotor connected to the driveshaft and is driven to rotate the first rotor relative to the second rotor through electromagnetic operations of the first rotor and the second rotor.

The present invention is directed to a first control method of a drive system including: an internal combustion engine equipped with an exhaust treatment catalyst in an exhaust system; a fuel exhaust adsorption unit that is arranged in the exhaust system to absorb a component of a fuel exhaust; and a cranking structure that cranks the internal combustion engine. In response to a start instruction of the internal combustion engine the first control method of the drive system (a) controls the cranking structure to crank the internal combustion engine; and (b) controls the internal combustion engine to start fuel injection from a fuel injection valve and eventually start the internal combustion engine after cranking of the internal combustion engine progresses to a specific extent that is required for substantial elimination of a fuel vapor accumulated in an air intake system and in a combustion chamber.

In response to a start instruction of the internal combustion engine that is equipped with the exhaust treatment catalyst and the fuel exhaust adsorption unit in the exhaust system, the first control method of the drive system of the invention controls the cranking structure to crank the internal combustion engine and controls the internal combustion engine to start fuel injection from the fuel injection valve and eventually start the internal combustion engine after cranking of the internal combustion engine progresses to the specific extent that is required for substantial elimination of the fuel vapor accumulated in the air intake system and in the combustion chamber. The fuel injection is performed to start the internal combustion engine after substantial elimination of the fuel vapor accumulated in the air intake system and in the combustion chamber. This arrangement effectively prevents a variation in air-fuel ratio on or immediately after a start of the internal combustion engine. The fuel exhaust adsorption unit absorbs the component of the fuel exhaust flowed into the exhaust system in the course of cranking the internal combustion engine. This arrangement improves emission on a start of the internal combustion engine.

The present invention is directed to a second control method of a drive system including: an internal combustion engine equipped with an exhaust treatment catalyst in an exhaust system; a fuel exhaust adsorption unit that is arranged in the exhaust system to absorb a component of a fuel exhaust; a changeover mechanism that is driven by an actuator to change over a flow path of the fuel exhaust between a first gas pathway that causes a main portion of the fuel exhaust introduced into the exhaust system to be discharged without transmission through the fuel exhaust adsorption unit and a second gas pathway that causes all the fuel exhaust introduced into the exhaust system to be discharged after transmission through the fuel exhaust adsorption unit; and a cranking structure that cranks the internal combustion engine. In response to a start instruction of the internal combustion engine, the second control method of the drive system (a) drives the actuator and controlling the changeover mechanism to change over the flow path of the fuel exhaust to the second gas pathway; and (b) controls the internal combustion engine to start cranking the internal combustion engine and eventually start the internal combustion engine after the changeover of the flow path of the fuel exhaust to the second gas pathway by the changeover mechanism.

In the second control method of the drive system of the invention, the changeover mechanism is driven by the actuator to change over the flow path of the fuel exhaust between the first gas pathway that causes the main portion of the fuel exhaust introduced into the exhaust system to be discharged without transmission through the fuel exhaust adsorption unit and the second gas pathway that causes all the fuel exhaust introduced into the exhaust system to be discharged after transmission through the fuel exhaust adsorption unit. In response to a start instruction of the internal combustion engine that is equipped with the exhaust treatment catalyst and the fuel exhaust adsorption unit in the exhaust system, the second control method of the drive system of the invention drives the actuator and controls the changeover mechanism to change over the flow path of the fuel exhaust to the second gas pathway and controls the internal combustion engine to start cranking the internal combustion engine and eventually start the internal combustion engine after the changeover of the flow path of the fuel exhaust to the second gas pathway by the changeover mechanism. This arrangement desirably prevents direct discharge of the fuel vapor, which is accumulated in the air intake system and is flowed into the exhaust system in the course of cranking the internal combustion engine, without transmission through the fuel exhaust adsorption unit and thus improves the emission on a start of the internal combustion engine.

### BRIEF DESCRIPTION OF THE DRAWINGS

FIG. 1 schematically illustrates the configuration of a hybrid vehicle equipped with a drive system in one embodiment of the invention;

FIG. 2 schematically shows the structure of an engine mounted on the hybrid vehicle of the embodiment;

FIG. 3 schematically illustrates the structure of a second catalytic conversion unit included in the hybrid vehicle of the embodiment;

FIG. 4 is a flowchart showing a start control routine executed by a hybrid electronic control unit included in the hybrid vehicle of the embodiment;

FIG. 5 is a flowchart showing a drive control routine executed by the hybrid electronic control unit included in the hybrid vehicle of the embodiment;

FIG. 6 shows a variation in output limit Wout of a battery against batter temperature Tb;

FIG. 7 shows a variation in output limit correction factor for the output limit Wout against state of charge SOC of the battery;

FIG. 8 shows one example of a torque demand setting map;

FIG. 9 is an alignment chart showing torque-rotation speed dynamics of respective rotational elements included in a power distribution integration mechanism in the hybrid vehicle of the embodiment; and

FIG. 10 schematically illustrates the configuration of another hybrid vehicle as one modified example.

### BEST MODES OF CARRYING OUT THE INVENTION

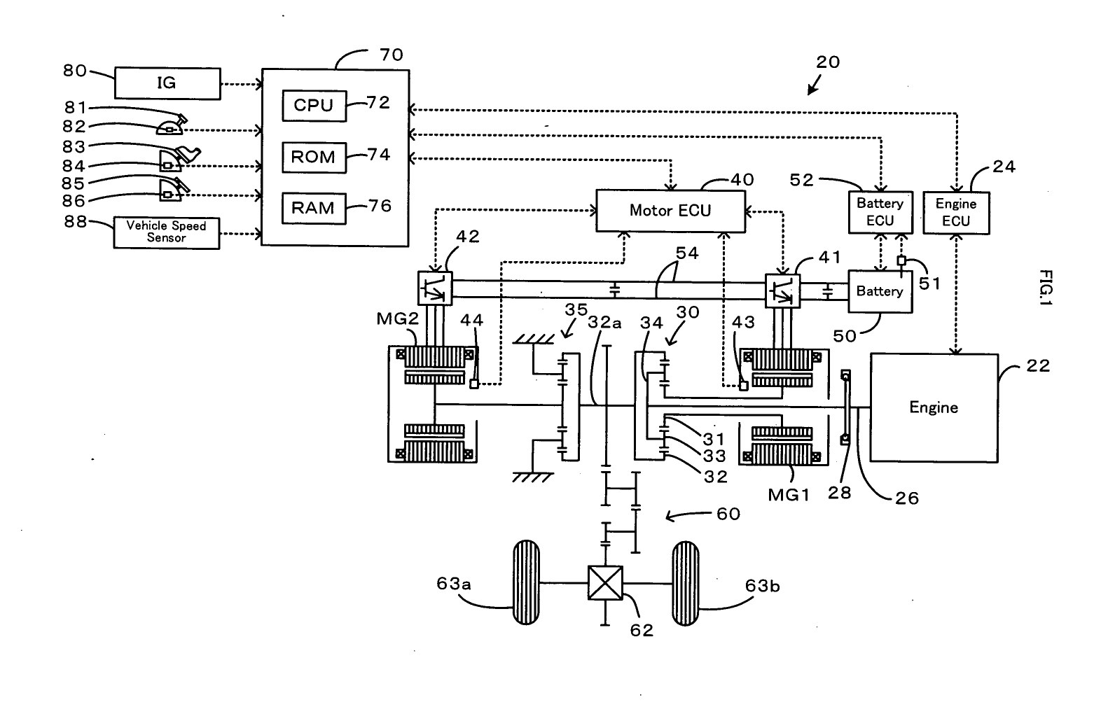

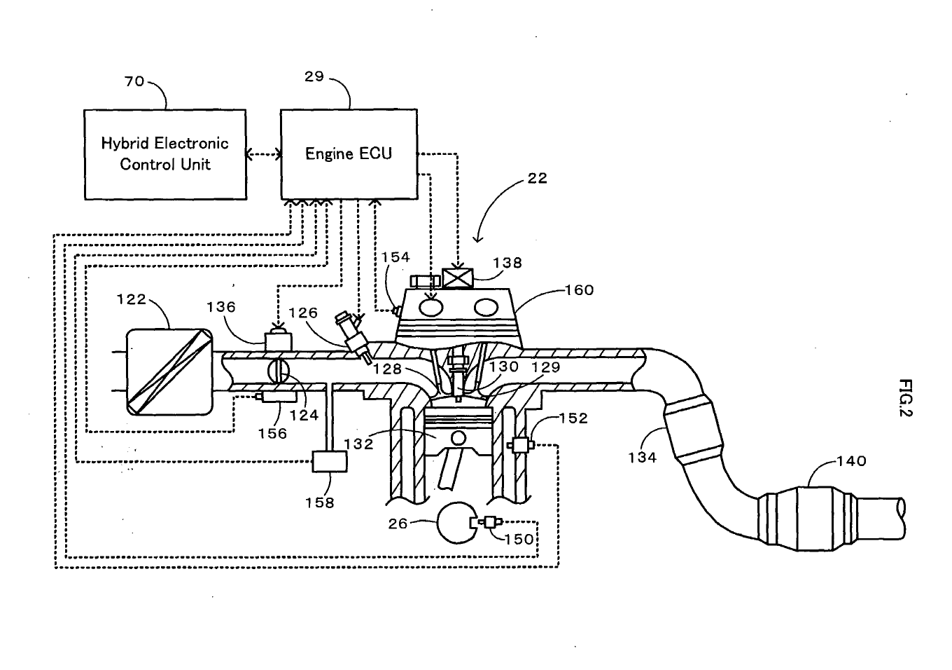

One mode of carrying out the invention is described below as a preferred embodiment with reference to the accompanied drawings. FIG. 1 schematically illustrates the configuration of a hybrid vehicle 20 equipped with a drive system in one embodiment of the invention. FIG. 2 schematically shows the structure of an engine 22 mounted on the hybrid vehicle 20 of the embodiment. As illustrated in FIG. 1, the hybrid vehicle 20 of the embodiment includes the engine 22, a three shaft-type power distribution integration mechanism 30 that is linked to a crankshaft 26 or an output shaft of the engine 22 via a damper 28, a motor MG1 that is connected to the power distribution integration mechanism 30 and has power generation capability, a reduction gear 35 that is attached to a ring gear shaft 32a or a driveshaft linked with the power distribution integration mechanism 30, a motor MG2 that is connected to the reduction gear 35, and a hybrid electronic control unit 70 that controls the operations of the whole drive system in the hybrid vehicle 20.

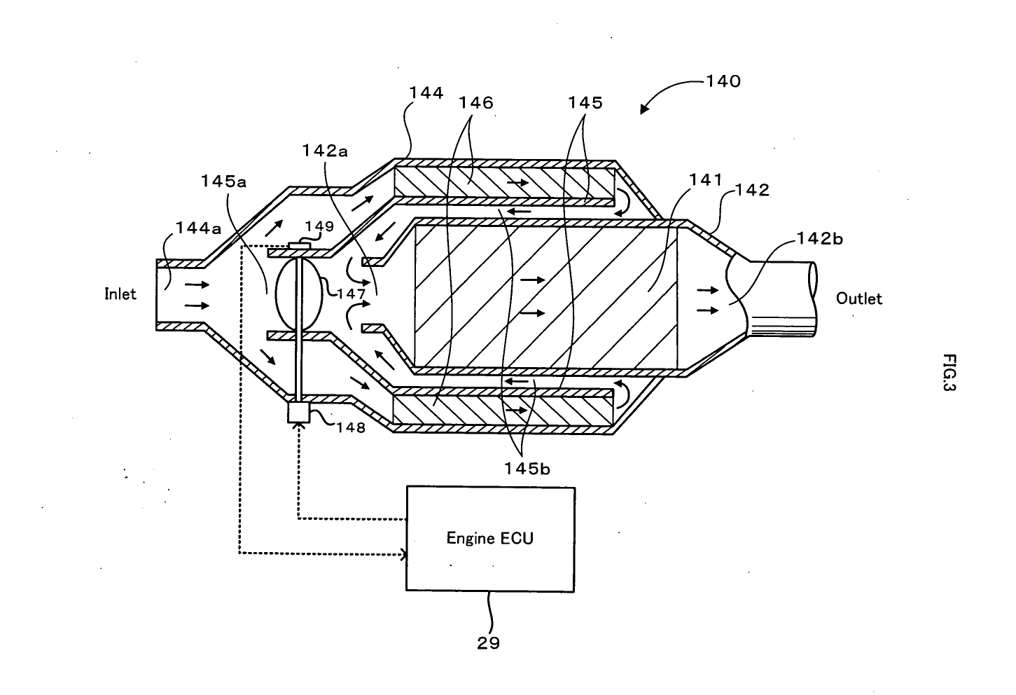

The engine 22 is an internal combustion engine that consumes a hydrocarbon fuel, such as gasoline or light oil, to output power. As shown in FIG. 2, the air cleaned by an air cleaner 122 and taken in via a throttle valve 124 is mixed with the atomized gasoline injected by an injector 126 to the air-fuel mixture. The air-fuel mixture is introduced into a combustion chamber via an intake valve 128. The introduced air-fuel mixture is ignited with spark made by a spark plug 130 to be explosively combusted. The reciprocating motions of a piston 132 by the combustion energy are converted into rotational motions of the crankshaft 26. The exhaust from the engine 22 sequentially goes through a first catalytic conversion unit 134 (filled with three-way catalyst) and a second catalytic conversion unit 140 to convert toxic components included in the exhaust, that is, carbon monoxide (CO), hydrocarbons (HC), and nitrogen oxides (NOx), into harmless components, and is discharged to the outside air. FIG. 3 schematically illustrates the structure of the second catalytic conversion unit 140.

As illustrated in FIG. 3, the second catalytic conversion unit 140 includes a cylindrical inner case 142 filled with a three-way catalyst 141, a cylindrical outer case 144 having a larger diameter than the diameter of the inner case 142, a cylindrical partition member 145 having an opening 145a and forming a bypass pathway 145b, an HC adsorbent 146 packed in a ring-shaped space formed in the bypass pathway 145b by an outer wall of the partition member 145 and an inner wall of the outer case 144, an exhaust flow changeover valve 147 attached to the opening 145a of the partition member 145, and an actuator 148 driven to open and close the exhaust flow changeover valve 147. The actuator 148 is, for example, an electric actuator. An outer wall of the smaller-diameter inner case 142 and an inner wall of the larger-diameter outer case 144 define a ring-shaped space. The inner case 142 and the outer case 144 are arranged, such that an inlet 142a of the inner case 142 is aligned with an inlet 144a of the outer case 144 across some space. The opening 145a of the partition member 145 connects the inlet 142a of the inner case 142 to the inlet 144a of the outer case 144. The partition member 145 is designed to have a diameter larger than the diameter of the inner case 142 but smaller than the diameter of the outer case 144. The partition member 145 parts the ring-shaped space defined by the outer wall of the inner case 142 and the inner wall of the outer case 144 to form the bypass pathway 145b. The bypass pathway 145b does not directly lead a gas flow introduced through the inlet 144a of the outer case 144 to the inlet 142a of the inner case 142 but bypasses the gas flow. In a closed position of the exhaust flow changeover valve 147, a gas flow introduced via the inlet 144a of the outer case 144 into the second catalytic conversion unit 140 is lead through the bypass conduit 145b including the HC adsorbent 146 to the inlet 142a of the inner case 142. The gas flow then goes through the three-way catalyst 141 and is flowed out of the second catalytic conversion unit 140 via an outlet 142b of the inner case 142. In an open position of the exhaust flow changeover valve 147, on the other hand, a main portion of the gas flow introduced via the inlet 144a of the outer case 144 into the second catalytic conversion unit 140 is directly led to the inlet 142a of the inner case 142 via the open exhaust flow changeover valve 147, while a residual portion of the gas flow goes through the bypass pathway 145b to the inlet 142a of the inner case 142. The gas flow then goes through the three-way catalyst 141 and is flowed out of the second catalytic conversion unit 140 via the outlet 142b of the inner case 142. The three-way catalyst 141 mainly consists of an oxidation catalyst, such as platinum (Pt) or palladium (Pd), a reduction catalyst, such as rhodium (Rh), and an assisting catalyst, such as ceria (CeO₂). The three-way catalyst 141 is active at high temperatures. The functions of the oxidation catalyst convert CO and HC included in the exhaust into water (H₂O) and carbon dioxide (CO₂). The functions of the reduction catalyst convert NOₓ included in the exhaust into nitrogen (N₂) and oxygen (O₂). The HC adsorbent 146 mainly composed of zeolite absorbs HC at low temperatures and releases the absorbed HC at high temperatures. In a low temperature range where the three-way catalyst 141 is inactive, setting the exhaust flow changeover valve 147 to the closed position enables HC to be temporarily absorbed by the HC adsorbent 146. With a temperature rise, the three-way catalyst 141 is activated to convert the HC absorbed by the HC adsorbent 146.

The engine 22 is under control of an engine electronic control unit 24 (hereafter referred to as engine ECU 24). The engine ECU 24 receives, via its input port (not shown), signals from various sensors that measure and detect the conditions of the engine 22. The signals input into the engine ECU 24 include a crank position from a crank position sensor 150 measured as the rotational position of the crankshaft 26, a cooling water temperature from a water temperature sensor 152 measured as the temperature of cooling water for the engine 22, a cam position from a cam position sensor 154 measured as the rotational position of a camshaft driven to open and close the intake valve 128 and an exhaust valve for gas intake and exhaust into and from the combustion chamber, a throttle valve position from a throttle valve position sensor 156 detected as the opening of the throttle valve 124, an intake negative pressure or an amount of intake air from a vacuum sensor 158 measured as the load of the engine 22, and a valve-closing switch signal from a valve-closing switch 149 detecting the setting of the exhaust flow changeover valve 147 in the closed position. The engine ECU 24 outputs, via its output port (not shown), diverse control signals and driving signals to drive and control the engine 22, for example, driving signals to the fuel injection valve 126, driving signals to a throttle motor 136 for regulating the position of the throttle valve 124, control signals to an ignition coil 138 integrated with an igniter, control signals to a variable valve timing mechanism 160 to vary the open and close timings of the intake valve 128, and driving signals to the actuator 148 for opening and closing the exhaust flow changeover valve 147. The engine ECU 24 communicates with the hybrid electronic control unit 70. The engine ECU 24 receives control signals from the hybrid electronic control unit 70 to drive and control the engine 22, while outputting data regarding the driving conditions of the engine 22 to the hybrid electronic control unit 70 according to the requirements.

The power distribution and integration mechanism 30 has a sun gear 31 that is an external gear, a ring gear 32 that is an internal gear and is arranged concentrically with the sun gear 31, multiple pinion gears 33 that engage with the sun gear 31 and with the ring gear 32, and a carrier 34 that holds the multiple pinion gears 33 in such a manner as to allow free revolution thereof and free rotation thereof on the respective axes. Namely the power distribution and integration mechanism 30 is constructed as a planetary gear mechanism that allows for differential motions of the sun gear 31, the ring gear 32, and the carrier 34 as rotational elements. The carrier 34, the sun gear 31, and the ring gear 32 in the power distribution and integration mechanism 30 are respectively coupled with the crankshaft 26 of the engine 22, the motor MG1, and the reduction gear 35 via ring gear shaft 32a. While the motor MG1 functions as a generator, the power output from the engine 22 and input through the carrier 34 is distributed into the sun gear 31 and the ring gear 32 according to the gear ratio. While the motor MG1 functions as a motor, on the other hand, the power output from the engine 22 and input through the carrier 34 is combined with the power output from the motor MG1 and input through the sun gear 31 and the composite power is output to the ring gear 32. The power output to the ring gear 32 is thus finally transmitted to the driving wheels 63a and 63b via the gear mechanism 60, and the differential gear 62 from ring gear shaft 32a.

Both the motors MG1 and MG2 are known synchronous motor generators that are driven as a generator and as a motor. The motors MG1 and MG2 transmit electric power to and from a battery 50 via inverters 41 and 42. Power lines 54 that connect the inverters 41 and 42 with the battery 50 are constructed as a positive electrode bus line and a negative electrode bus line shared by the inverters 41 and 42. This arrangement enables the electric power generated by one of the motors MG1 and MG2 to be consumed by the other motor. The battery 50 is charged with a surplus of the electric power generated by the motor MG1 or MG2 and is discharged to supplement an insufficiency of the electric power. When the power balance is attained between the motors MG1 and MG2, the battery 50 is neither charged nor discharged. Operations of both the motors MG1 and MG2 are controlled by a motor electronic control unit (hereafter referred to as motor ECU) 40. The motor ECU 40 receives diverse signals required for controlling the operations of the motors MG1 and MG2, for example, signals from rotational position detection sensors 43 and 44 that detect the rotational positions of rotors in the motors MG1 and MG2 and phase currents applied to the motors MG1 and MG2 and measured by current sensors (not shown). The motor ECU 40 outputs switching control signals to the inverters 41 and 42. The motor ECU 40 communicates with the hybrid electronic control unit 70 to control operations of the motors MG1 and MG2 in response to control signals transmitted from the hybrid electronic control unit 70 while outputting data relating to the operating conditions of the motors MG1 and MG2 to the hybrid electronic control unit 70 according to the requirements.

The battery 50 is under control of a battery electronic control unit (hereafter referred to as battery ECU) 52. The battery ECU 52 receives diverse signals required for control of the battery 50, for example, an inter-terminal voltage measured by a voltage sensor (not shown) disposed between terminals of the battery 50, a charge-discharge current measured by a current sensor (not shown) attached to the power line 54 connected with the output terminal of the battery 50, and a battery temperature Tb measured by a temperature sensor 51 attached to the battery 50. The battery ECU 52 outputs data relating to the state of the battery 50 to the hybrid electronic control unit 70 via communication according to the requirements. The battery ECU 52 calculates a state of charge (SOC) of the battery 50, based on the accumulated charge-discharge current measured by the current sensor, for control of the battery 50.

The hybrid electronic control unit 70 is constructed as a microprocessor including a CPU 72, a ROM 74 that stores processing programs, a RAM 76 that temporarily stores data, and a non-illustrated input-output port, and a non-illustrated communication port. The hybrid electronic control unit 70 receives various inputs via the input port: an ignition signal from an ignition switch 80, a gearshift position SP from a gearshift position sensor 82 that detects the current position of a gearshift lever 81, an accelerator opening Acc from an accelerator pedal position sensor 84 that measures a step-on amount of an accelerator pedal 83, a brake pedal position BP from a brake pedal position sensor 86 that measures a step-on amount of a brake pedal 85, and a vehicle speed V from a vehicle speed sensor 88. The hybrid electronic control unit 70 communicates with the engine ECU 24, the motor ECU 40, and the battery ECU 52 via the communication port to transmit diverse control signals and data to and from the engine ECU 24, the motor ECU 40, and the battery ECU 52, as mentioned previously.

The hybrid vehicle 20 of the embodiment thus constructed calculates a torque demand to be output to the ring gear shaft 32a functioning as the drive shaft, based on observed values of a vehicle speed v and an accelerator opening Acc, which corresponds to a driver's step-on amount of an accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a. The torque conversion drive mode is equivalent to the charge-discharge drive mode under the condition of the charge-discharge power of the battery 50 equal to 0. Namely the torque conversion drive mode is regarded as one type of the charge-discharge drive mode. The hybrid vehicle 20 of the embodiment is accordingly driven with a switchover of the drive mode between the motor drive mode and the charge-discharge drive mode.

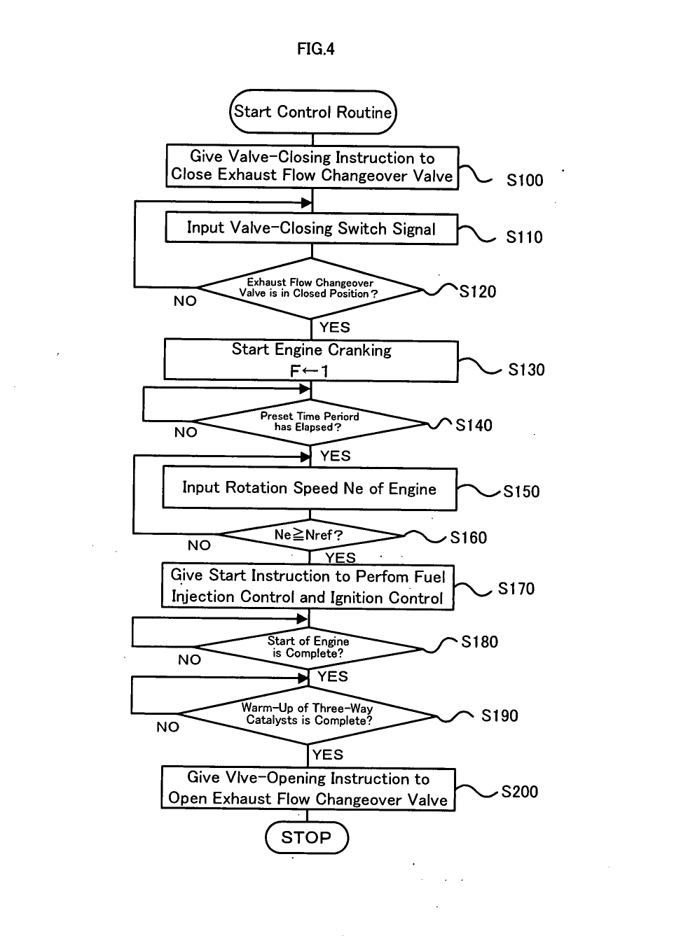

The description regards the operations of the hybrid vehicle 20 of the embodiment having the configuration discussed above, especially a series of start control for a first start of the engine 22 after system activation. FIG. 4 is a flowchart showing a start control routine executed by the hybrid electronic control unit 70. This start control routine is triggered by a first start instruction of the engine 22 after system activation.

In the start control routine of FIG. 4, the CPU 72 of the hybrid electronic control unit 70 first gives a valve-closing instruction to the engine ECU 24 to close the exhaust flow changeover valve 147 (step S100). The engine ECU 24 receives the valve-closing instruction and actuates and controls the actuator 148 to close the exhaust flow changeover valve 147. The CPU 72 inputs a valve-closing switch signal (step S110) and confirms the setting of the exhaust flow changeover valve 147 in the closed position (step S120). The valve-closing switch signal output from the valve-closing switch 149 is received from the engine ECU 24 by communication. After confirmation of the closed position of the exhaust flow changeover valve 147, the CPU 72 sets a value ‘1’ to a flag F to start cranking the engine 22 according to a drive control routine described later (step S130).

The CPU 72 waits until elapse of a preset time period since the start of cranking the engine 22 (step S140) and inputs a rotation speed Ne of the engine 22 (step S150). When the input rotation speed Ne of the engine 22 reaches or exceeds a preset reference rotation speed Nref (step S160), the CPU 72 gives a start instruction to the engine ECU 24 to perform fuel injection control and ignition control (step S170). The fuel injection from the fuel injection valve 126 starts after elapse of the preset time period for cranking the engine 22, because of the following reason. In a stop condition of the engine 22, the fuel vapor may be accumulated in an air intake system due to oil-tight leakage of the fuel injection valve 126 with elapse of time. The accumulated fuel vapor undesirably causes a variation in air-fuel ratio on or immediately after a restart of the engine 22, even when the fuel injection from the fuel injection valve 126 is regulated to attain a target air-fuel ratio. This variation in air-fuel ratio may lead to some trouble, for example, a misfire. The preset time period is accordingly specified as an engine cranking time required for substantial elimination of the fuel vapor accumulated in the air intake system and is set equal to 5 seconds in this embodiment.

The CPU 72 subsequently specifies whether the start of the engine 22 is complete or incomplete (step S180). In the case of the complete start of the engine 22, the CPU 72 waits until complete warm-up of the first catalytic conversion unit 134 (filled with the three-way catalyst) and the three-way catalyst 141 included in the second catalytic conversion unit 140 (step S190) and gives a valve-opening instruction to the engine ECU 24 to open the exhaust flow changeover valve 147 (step S200). The start control routine is then terminated. The HC included in the exhaust is converted by the catalytic functions of the three-way catalyst in the first catalytic conversion unit 134 and the three-way catalyst 141 in the second catalytic conversion unit 140. The HC absorbed by the HC adsorbent 146 is released at high temperatures and is introduced into the three-way catalyst 141 for catalytic conversion.

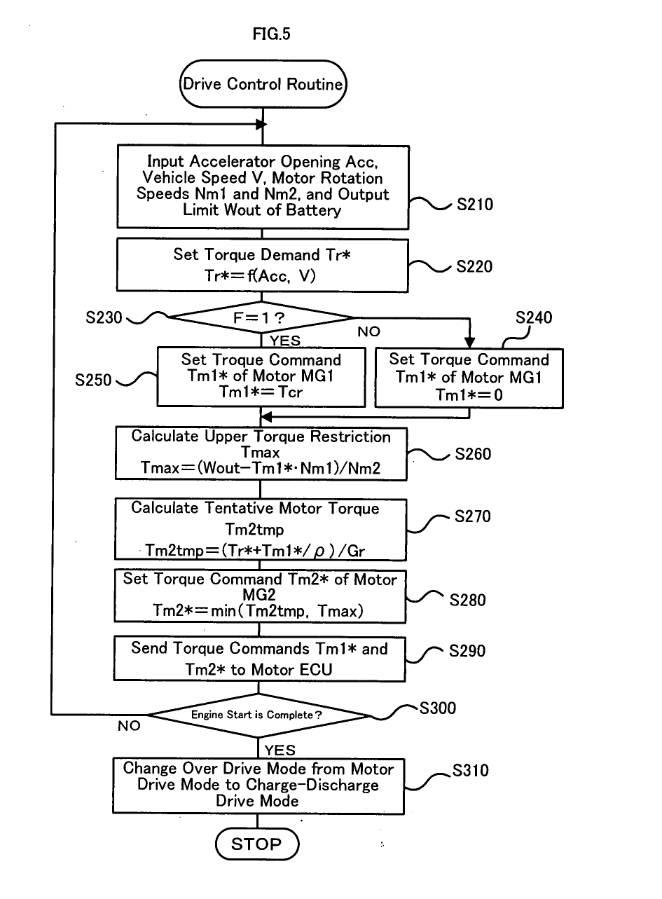

The description regards drive control of the engine 22 and the motors MG1 and MG2 at a start of the engine 22. FIG. 5 is a flowchart showing a drive control routine executed by the hybrid electronic control unit 70. This drive control routine is triggered by system activation. The drive control routine of FIG. 5 is thus executed in parallel with the start control routine of FIG. 4 on a first start of the engine 22 after system activation.

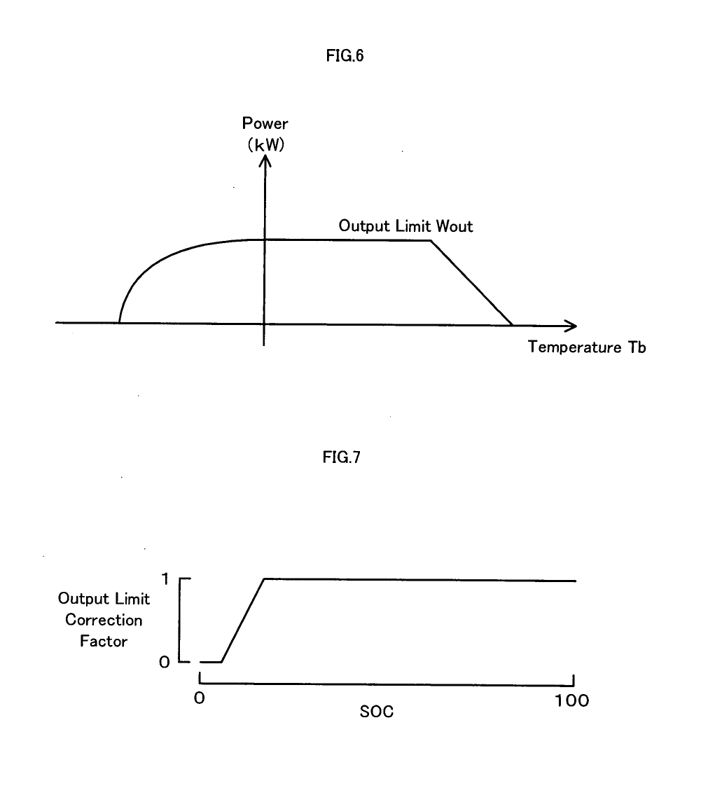

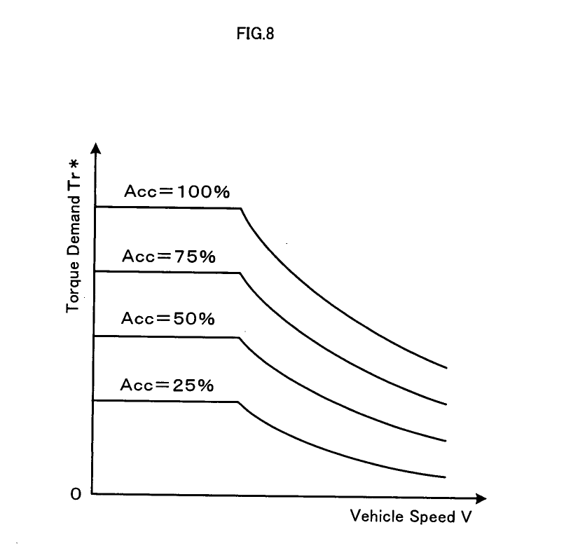

In the drive control routine of FIG. 5, the CPU 72 of the hybrid electronic control unit 70 first inputs required data for control, that is, the accelerator opening Acc from the accelerator pedal position sensor 84, the vehicle speed V from the vehicle speed sensor 88, rotation speeds Nm1 and Nm2 of the motors MG1 and MG2, and an output limit Wout of the battery 50 (step S210). The rotation speeds Nm1 and Nm2 of the motors MG1 and MG2 are computed from the rotational positions of the respective rotors in the motors MG1 and MG2 detected by the rotational position detection sensors 43 and 44 and are received from the motor ECU 40 by communication. The output limit Wout of the battery 50 is set corresponding to the battery temperature Tb of the battery 50 measured by the temperature sensor 51 and the state of charge SOC of the battery 50 and is received from the battery ECU 52 by communication. A concrete procedure of setting the output limit Wout of the battery 50 specifies a base value of the output limit Wout corresponding to the measured battery temperature Tb, specifies an output limit correction factor corresponding to the state of charge SOC of the battery 50, and multiplies the specified base value of the output limit Wout by the specified output limit correction factor to determine the output limit Wout of the battery 50. FIG. 6 shows a variation in output limit Wout of the battery 50 against the battery temperature Tb. FIG. 7 shows a variation in output limit correction factor for the output limit Wout against the state of charge SOC of the battery 50.

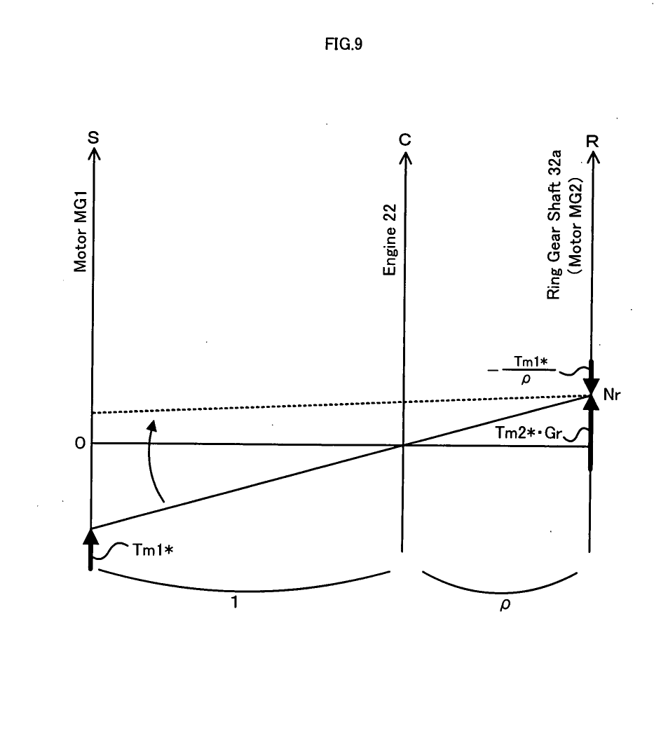

After the data input, the CPU 72 sets a torque demand Tr* to be output to the ring gear shaft 32a or the driveshaft linked with the drive wheels 63a and 63b as a required torque for the hybrid vehicle 20, based on the input accelerator opening Acc and the input vehicle speed V (step S220). A concrete procedure of setting the torque demand Tr* in this embodiment stores in advance variations in torque demand Tr* against the accelerator opening Acc and the vehicle speed V as a torque demand setting map in the ROM 74 and reads the torque demand Tr* corresponding to the given accelerator opening Acc and the given vehicle speed V from this torque demand setting map. One example of the torque demand setting map is shown in FIG. 8.

The CPU 72 subsequently identifies the value of the flag F representing a start of cranking the engine 22 (step S230). When the flag F is equal to 0, a value ‘0’ is set to a torque command Tm1* as a torque to be output from the motor MG1 (step S240). When the flag F is equal to 1, on the other hand, a cranking torque Tcr required for cranking the engine 22 is set to the torque command Tm1* of the motor MG1 (step S250). FIG. 9 is an alignment chart showing torque-rotation speed dynamics of the respective rotational elements included in the power distribution integration mechanism 30. The left axis ‘S’ represents a rotation speed of the sun gear 31 that is equivalent to the rotation speed Nm1 of the motor MG1. The middle axis ‘C’ represents a rotation speed of the carrier 34 that is equivalent to the rotation speed Ne of the engine 22. The right axis ‘R’ represents a rotation speed Nr of the ring gear 32 that is equivalent to division of the rotation speed Nm2 of the motor MG2 by a gear ratio Gr of the reduction gear 35. Output of an upward torque on the axis ‘S’ from the motor MG1 cranks the engine 22. Two thick arrows on the axis ‘R’ represent a torque (−Tm1*/ρ) applied to the ring gear shaft 32a by output of the torque Tm1* from the motor MG1 and a torque (Tm2*·Gr) applied to the ring gear shaft 32a via the reduction gear 35 by output of a torque Tm2* from the motor MG2.

After setting the torque command Tm1* of the motor MG1, the CPU 72 calculates an upper torque restriction Tmax as a maximum possible torque output from the motor MG2 according to Equation (1) given below (step S260). The calculation subtracts the product of the torque command Tm1* and the current rotation speed Nm1 of the motor MG1, which represents the power consumption (power generation) of the motor MG1, from the output limit Wout of the battery 50 and divides the difference by the current rotation speed Nm2 of the motor MG2:

Tmax=(Wout−Tm1*·Nm1)/Nm2 (1)

The CPU 72 then calculates a tentative motor torque Tm2tmp as a torque to be output from the motor MG2 from the torque demand Tr*, the torque command Tm1* of the motor MG1, a gear ratio ρ of the power distribution integration mechanism 30, and the gear ratio Gr of the reduction gear 35 according to Equation (2) given below (step S270):

Tm2tmp=(Tr*+Tm1*/ρ)/Gr (2)

The CPU 72 compares the calculated upper torque restriction Tmax with the calculated tentative motor torque Tm2tmp and sets the smaller to a torque command Tm2* of the motor MG2 (step S280). Such setting of the torque command Tm2* of the motor MG2 restricts the torque demand Tr* to be output to the ring gear shaft 32a or the driveshaft within the range of the output limit Wout of the battery 50. Equation (2) is readily led from the alignment chart of FIG. 9.

After setting the torque commands Tm1* and Tm2* of the motors MG1 and MG2 in the above manner, the CPU 72 sends the torque commands Tm1* and Tm2* to the motor ECU 40 (step S290). The motor ECU 40 receives the torque commands Tm1* and Tm2* and performs switching control of the switching elements included in the respective inverters 41 and 42 to drive the motor MG1 with the torque command Tm1* and the motor MG2 with the torque command Tm2*.

The processing of steps S210 to S290 is repeated until completion of the start of the engine 22 (step S300) by execution of the start control routine of FIG. 4. After completion of the start of the engine 22 (step S300), the CPU 72 changes over the drive mode of the hybrid vehicle 20 from the motor drive mode to the charge-discharge drive mode (step S310) and exits from this drive control routine. As described previously, the start control routine of FIG. 4 starts the fuel injection control and the ignition control after elapse of the preset time period (for example, 5 seconds) for cranking the engine 22. A relatively long time is thus required for a complete start of the engine 22. On the complete start of the engine 22, the torque demand Tr* is output to the ring gear shaft 32a or the driveshaft.

As described above, at the time of a first start of the engine 22 after system activation, the hybrid vehicle 20 of the embodiment starts fuel injection from the fuel injection valve 126 to start the engine 22 after cranking the engine 22 for the preset time period. Such control ensures start of fuel injection from the fuel injection valve 126 after substantial elimination of the fuel vapor accumulated in the air intake system. This effectively prevents a variation of the air-fuel ratio and stabilizes the drive of the hybrid vehicle 20 on or immediately after a start of the engine 22. The motor MG2 is driven and controlled to output the torque demand Tr* to the ring gear shaft 32a or the driveshaft. The drive control of this embodiment satisfies output of the torque demand Tr* to the ring gear shaft 32a, although requiring a relatively long time for a complete start of the engine 22.

The hybrid vehicle 20 of the embodiment starts cranking the engine 22 after closing the exhaust flow changeover valve 147. Such control enables the fuel vapor accumulated in the air intake system to be effectively absorbed by the HC adsorbent 146. This improves the emission on the start of the engine 22. The closed position of the exhaust flow changeover valve 147 is confirmed by the valve-closing switch signal output from the valve-closing switch 149. This further ensures effective absorption of the fuel vapor accumulated in the air intake system to the HC adsorbent 146.

The hybrid vehicle 20 of the embodiment starts cranking the engine 22 after confirming the closed position of the exhaust flow changeover valve 147 based on the valve-closing switch signal output from the valve-closing switch 149. This method is, however, not restrictive but any other suitable technique may be applied to confirm the closed position of the exhaust flow changeover valve 147. One applicable technique measures the electric current applied to the electric actuator 148 for confirmation of the closed position of the exhaust flow changeover valve 147. A modified flow of the start control may not directly confirm the closed position of the exhaust flow changeover valve 147 but may start cranking the engine 22 after elapse of a preset time period since output of a valve-closing instruction. When a distance between the air intake system and the HC adsorbent 146 is in a specified range, the start control may immediately start cranking the engine 22 without confirming the closed position of the exhaust flow changeover valve 147.

In the hybrid vehicle 20 of the embodiment, the second catalytic conversion unit 140 is designed to introduce the HC, which is absorbed by the HC adsorbent 146 and is later released from the HC adsorbent 146, into the three-way catalyst 141 for catalytic conversion. The HC absorbed by the HC adsorbent 146 and later released from the HC adsorbent 146 may directly be led to the air intake system via an EGR pipe to be burned out.

The hybrid vehicle 20 of the embodiment includes two catalytic conversion units, that is, the first catalytic conversion unit 134 and the second catalytic conversion unit 140. The hybrid vehicle may, however, have only one catalytic conversion unit, that is, the second catalytic conversion unit 140, or may have three or more catalytic conversion units.

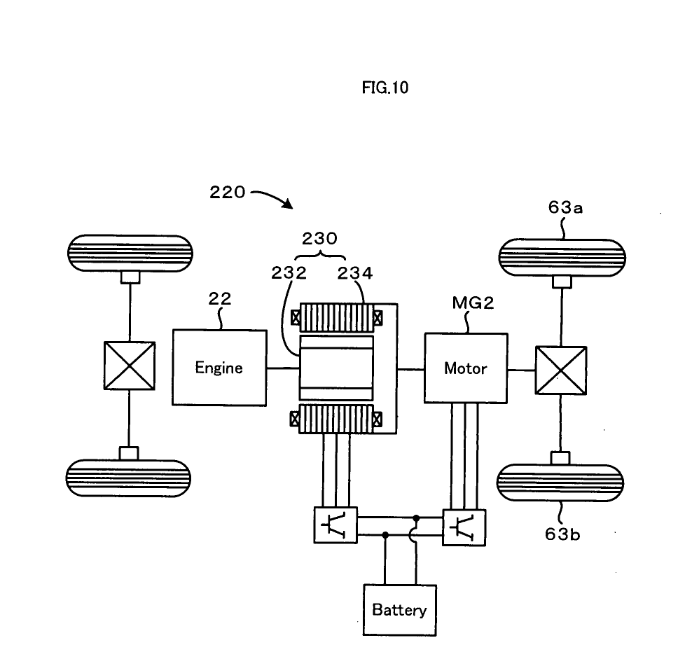

In the hybrid vehicle 20 of the embodiment, the power of the engine 22 is output via the power distribution integration mechanism 30 to the ring gear shaft 32a or the driveshaft connected to the drive wheels 63a and 63b. The technique of the invention is, however, not restricted to this configuration but may also be applicable to a hybrid vehicle 220 of a modified configuration shown in FIG. 10. The hybrid vehicle 220 of FIG. 10 has a pair-rotor motor 230 including an inner rotor 232 connected to the crankshaft 26 of the engine 22 and an outer rotor 234 connected to a driveshaft for output of power to the drive wheels 63a and 63b. The pair-rotor motor 230 transmits part of the output power of the engine 22 to the driveshaft, while converting the residual engine output power into electric power.

The technique of the invention is applicable to the hybrid vehicle of any other structure including: an engine equipped with an HC adsorbent and an exhaust treatment catalyst for catalytic conversion in an exhaust system; and a cranking device for cranking the engine. The technique of the invention is not restricted to the hybrid vehicles but is also applicable to conventional motor vehicles without a drive motor, as well as drive systems that are not mounted on the motor vehicles.

The embodiment discussed above is to be considered in all aspects as illustrative and not restrictive. There may be many modifications, changes, and alterations without departing from the scope or spirit of the main characteristics of the present invention.

### INDUSTRIAL APPLICABILITY

The technique of the present invention is preferably applicable to the manufacturing industries of drive systems and automobiles.

1-9. (canceled)

10. A drive system including an internal combustion engine equipped with an exhaust treatment catalyst in an exhaust system,
said drive system comprising:
a fuel exhaust adsorption unit that is arranged in the exhaust system to absorb a component of a fuel exhaust;
a changeover mechanism that is driven by an actuator to change over a flow path of the fuel exhaust between a first gas pathway that causes a main portion of the fuel exhaust introduced into the exhaust system to be discharged without transmission through the fuel exhaust adsorption unit and a second gas pathway that causes all the fuel exhaust introduced into the exhaust system to be discharged after transmission through the fuel exhaust adsorption unit;
a cranking structure that cranks the internal combustion engine; and
a start control module that, in response to a start instruction of the internal combustion engine, drives the actuator and controls the changeover mechanism to change over the flow path of the fuel exhaust to the second gas pathway and controls the internal combustion engine to start cranking the internal combustion engine and eventually start the internal combustion engine after the changeover of the flow path of the fuel exhaust to the second gas pathway by the changeover mechanism.

11. A drive system in accordance with claim 10, said drive system further comprising:
a changeover detection unit that detects the changeover of the flow path of the fuel exhaust to the second gas pathway by the changeover mechanism,
wherein said start control module controls the cranking structure to start cranking the internal combustion engine, in response to detection of the changeover of the flow path of the fuel exhaust to the second gas pathway by the changeover detection unit.

12. A drive system in accordance with claim 10, wherein said start control module controls the internal combustion engine to start fuel injection from a fuel injection valve and eventually start the internal combustion engine after cranking of the internal combustion engine progresses to a specific extent that is required for substantial elimination of a fuel vapor accumulated in an air intake system and in a combustion chamber.

13. A drive system in accordance with claim 12, wherein said start control module controls the internal combustion engine to start the fuel injection from the fuel injection valve and start the internal combustion engine after cranking of the internal combustion engine continues for a predetermined time period, which expects the progress of cranking to the specific extent.

14. A drive system in accordance with claim 10, wherein said start control module functions in response to a first start instruction of the internal combustion engine after system activation.

15. A drive system in accordance with claim 10, wherein the exhaust treatment catalyst is arranged downstream the fuel exhaust adsorption unit to convert the component of the fuel exhaust absorbed by the fuel exhaust adsorption unit and later released from the fuel exhaust adsorption unit.

16. A drive system in accordance with claim 10, said drive system being designed to directly or indirectly use output power of the internal combustion engine and enable output of power to a driveshaft,
said drive system further comprising:
a driveshaft motor that outputs power to the driveshaft;
an accumulator unit that receives and transmits electric power from and to the driveshaft motor; and
a power demand setting module that sets a power demand in response to an operator's manipulation,
wherein said start control module controls the driveshaft motor to output a power equivalent to the set power demand to the driveshaft.

17. A drive system in accordance with claim 16, wherein said start control module controls the driveshaft motor to output the power equivalent to the set power demand to the driveshaft within an output limit of the accumulator unit.

18. A drive system in accordance with claim 16, said drive system further comprising:
an electric power-mechanical power input output mechanism that is connected with an output shaft of the internal combustion engine and with the driveshaft to function as the cranking structure with input and output of electric power and mechanical power and to output at least part of the output power of the internal combustion engine to the driveshaft after a start of the internal combustion engine.

19. A drive system in accordance with claim 18, wherein the electric power-mechanical power input output mechanism comprises: a three shaft-type power input output module that is linked to three shafts, the output shaft of the internal combustion engine, the driveshaft, and a third rotating shaft, and automatically inputs and outputs power from and to a residual one shaft based on powers input from and output to any two shafts among the three shafts; and a rotating shaft motor that is capable of inputting and outputting power from and to the third rotating shaft.

20. A drive system in accordance with claim 18, wherein the electric power-mechanical power input output mechanism comprises a pair-rotor motor that has a first rotor connected to the output shaft of the internal combustion engine and a second rotor connected to the driveshaft and is driven to rotate the first rotor relative to the second rotor through electromagnetic operations of the first rotor and the second rotor.

21. (canceled)

22. A control method of a drive system, said drive system comprising: an internal combustion engine equipped with an exhaust treatment catalyst in an exhaust system; a fuel exhaust adsorption unit that is arranged in the exhaust system to absorb a component of a fuel exhaust; a changeover mechanism that is driven by an actuator to change over a flow path of the fuel exhaust between a first gas pathway that causes a main portion of the fuel exhaust introduced into the exhaust system to be discharged without transmission through the fuel exhaust adsorption unit and a second gas pathway that causes all the fuel exhaust introduced into the exhaust system to be discharged after transmission through the fuel exhaust adsorption unit; and a cranking structure that cranks the internal combustion engine,
in response to a start instruction of the internal combustion engine,
said control method of the drive system
(a) driving the actuator and controlling the changeover mechanism to change over the flow path of the fuel exhaust to the second gas pathway; and
(b) controlling the internal combustion engine to start cranking the internal combustion engine and eventually start the internal combustion engine after the changeover of the flow path of the fuel exhaust to the second gas pathway by the changeover mechanism.
